(19) United States
(12) Patent Application Publication
(10) Pub. No.: US 2025/0361752 A1
(43) Pub. Date: Nov. 27, 2025

(54) CABINET WITH LIFT-UP DOOR

(71) Applicant: MACHAN INTERNATIONAL CO., LTD., Taichung City (TW)

(72) Inventors: Fu Wen Hsieh, Taichung City (TW); You Yuan Wu, Taichung City (TW); Wen Pin Hsieh, Taichung City (TW)

(21) Appl. No.: 19/031,777

(22) Filed: Jan. 18, 2025

(30) Foreign Application Priority Data
May 27, 2024 (TW) 113119566

(51) Int. Cl. E05D 3/18; E05D 15/56; E05F 5/06

(52) U.S. Cl. CPC E05D 3/18; E05D 15/565; E05F 5/06; E05Y 2900/20

(57) ABSTRACT

A cabinet includes a cabinet body, a door panel, and an opening and closing mechanism. A slide rail and a first pivoting portion are disposed within the cabinet body. The door panel has a sliding portion and a second pivoting portion, and the sliding portion is rotatably and slidably connected to the slide rail. The opening and closing mechanism includes a linkage member, which has a third pivoting portion pivotally connected to the first pivoting portion and a fourth pivoting portion pivotally connected to the second pivoting portion. Through this structure, the cabinet allows the user to easily open or close the door panel.

### BACKGROUND OF THE INVENTION

The present invention relates to a cabinet, particularly a cabinet with a lift-up door.

Taiwan Patent No. TWM504511 discloses a storage cabinet, which includes a cabinet body; a cover body disposed on the front side of the cabinet body to enclose a storage space with the cabinet body; the inner wall of the cabinet body is surrounded by a top plate, two side plates, a bottom plate, and a rear plate, and the cabinet extends in a substantially straight line from the front to the rear; a hinge is disposed on the front side of the cabinet body, and the cover body is pivotally disposed on the hinge for pivoting to open the cover body, which can be opened or closed in an opening direction by the hinge; the storage cabinet further includes a first slide rail unit disposed on the inner wall surface of the cabinet body. The first slide rail unit is disposed on two side plates of the cabinet body and extends from the front side of the cabinet body to the rear side from the hinge. The cover body is movably disposed on the hinge or the first slide rail unit. When the cover body is located at the hinge, it can be folded into the storage space along a first sliding direction.

However, to open the cover body of the abovementioned storage cabinet, the cover body must first be lifted to a horizontal position before it can be slid along the first slide rail unit and folded into the storage space. This operation requires two distinct actions to complete. In particular, during the folding process, the cover body must remain completely horizontal to avoid interference.

Thus, a need exists for a cabinet to mitigate and/or obviate the above disadvantages.

### SUMMARY OF THE INVENTION

A cabinet in the embodiment of the present invention includes a cabinet body, a door panel, and an opening and closing mechanism. A slide rail and a first pivoting portion are disposed within the cabinet body. The door panel has a sliding portion and a second pivoting portion. The sliding portion is rotatably and slidably connected to the slide rail. The opening and closing mechanism includes a linkage member, which has a third pivoting portion pivotally connected to the first pivoting portion and a fourth pivoting portion pivotally connected to the second pivoting portion.

In an embodiment, one side of the cabinet body along a horizontal direction is provided with an opening. The slide rail extends linearly along the horizontal direction. The slide rail has a front end adjacent to the opening and a rear end away from the opening. The first pivoting portion is disposed below the slide rail along a vertical direction. The cabinet body defines a virtual pivoting axis passing through the first pivoting portion and extending along the horizontal direction. The linkage member is rotatable relative to the cabinet body about the pivoting axis. The door panel has a top end and a bottom end opposite the top end. The sliding portion is adjacent to the top end. The second pivoting portion is disposed between the top end and the bottom end. The door panel is movable between a closed position and an open position. When the door panel is in the closed position, the top end is moved near the front end, and the bottom end is moved near a lower edge of the opening along the vertical direction, thereby closing the opening. When the door panel is in the open position, the sliding portion is moved near the rear end, and the bottom end is moved near an upper edge of the opening along the vertical direction, thereby not closing the opening.

In an embodiment, a fifth pivoting portion is disposed within the cabinet body. The linkage member is provided with a sixth pivoting portion. The opening and closing mechanism includes a damper. The damper is provided with a seventh pivoting portion and an eighth pivoting portion. The damper is retractable to change a distance between the seventh pivoting portion and the eighth pivoting portion. The seventh pivoting portion is pivotally connected to the fifth pivoting portion. The eighth pivoting portion is pivotally connected to the sixth pivoting portion.

In an embodiment, the fifth pivoting portion is disposed below the first pivoting portion along the vertical direction. The opening and closing mechanism defines a reference surface parallel to the pivoting axis and passing through the seventh pivoting portion and the eighth pivoting portion. When the door panel is in the closed position, the third pivoting portion is located on a side of the reference surface opposite to the opening, and the fourth pivoting portion is located on the other side of the reference surface adjacent to the opening. When the door panel is in the open position, both the third pivoting portion and the fourth pivoting portion are located on the side of the reference surface opposite to the opening.

In an embodiment, the sliding portion is provided with a shaft rod and a circular sliding block. The sliding block is sleeved around the shaft rod and disposed within the slide rail.

In an embodiment, the side of the cabinet body along the horizontal direction is provided with a side plate adjacent to the opening. The slide rail is connected to an upper edge of the side plate along the vertical direction. The first pivoting portion is disposed on the side plate.

The present invention will become clearer in light of the following detailed description of illustrative embodiments of this invention described in connection with the drawings.

### BRIEF DESCRIPTION OF DRAWINGS

FIG. 1 is a perspective view of a cabinet of an embodiment according to the present invention.

FIG. 2 is an exploded perspective view of the cabinet of FIG. 1.

FIG. 3 is an exploded perspective view of an opening and closing mechanism of the cabinet of FIG. 1.

FIG. 4 is another exploded perspective view of the opening and closing mechanism of the cabinet of FIG. 1.

FIG. 5 is a cross-sectional view of the cabinet of FIG. 1 and shows a door panel in a closed position.

FIG. 6 is another cross-sectional view of the cabinet of FIG. 1 and shows the door panel from the closed position to an open position.

FIG. 7 is a further cross-sectional view of the cabinet of FIG. 1 and shows the door panel in the open position.

### DETAILED DESCRIPTION OF THE INVENTION

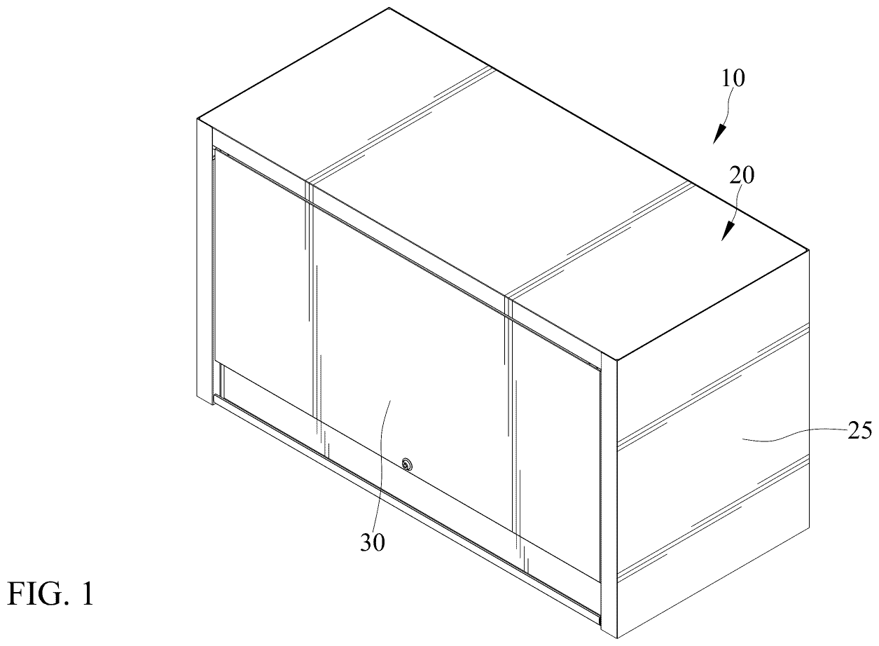

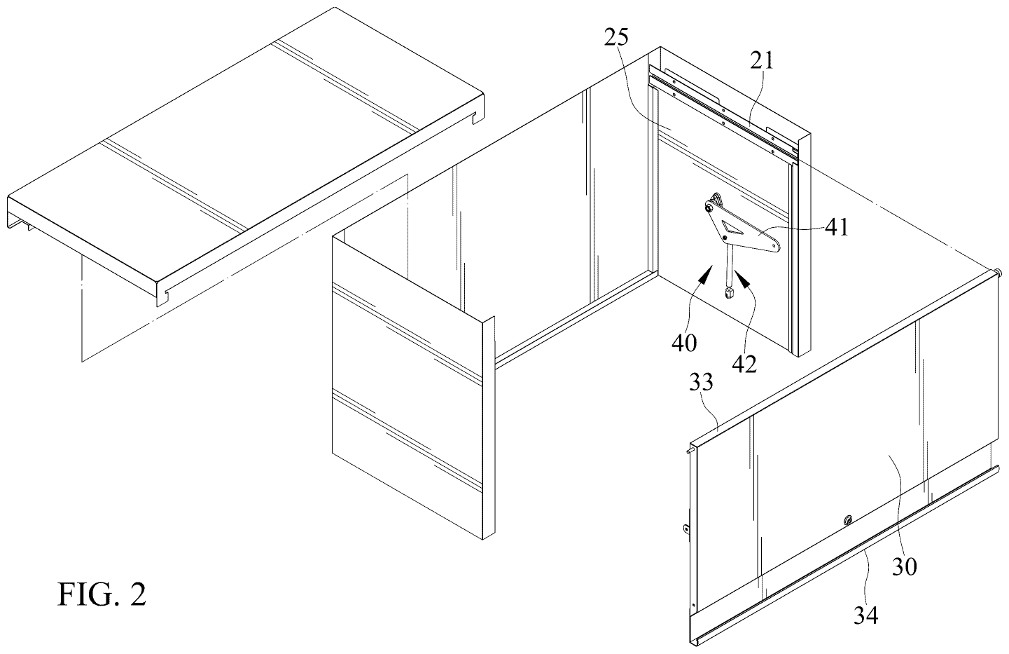

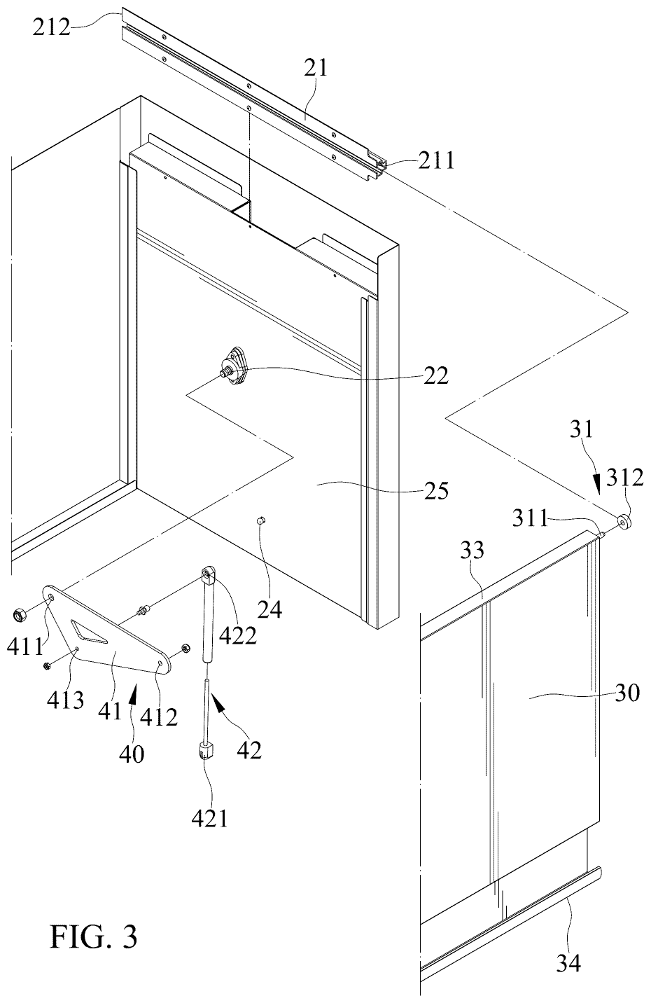

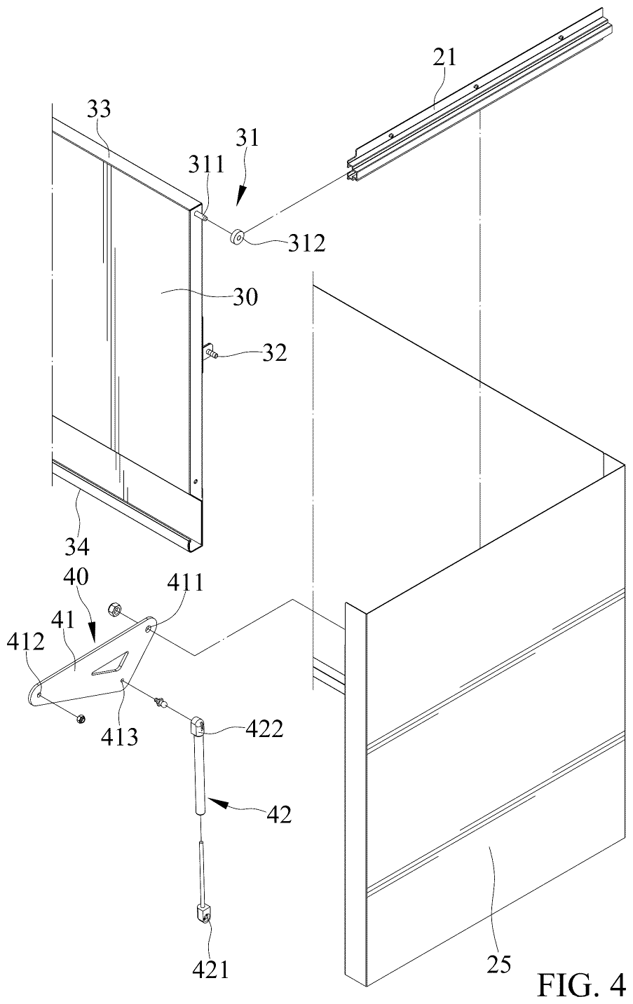

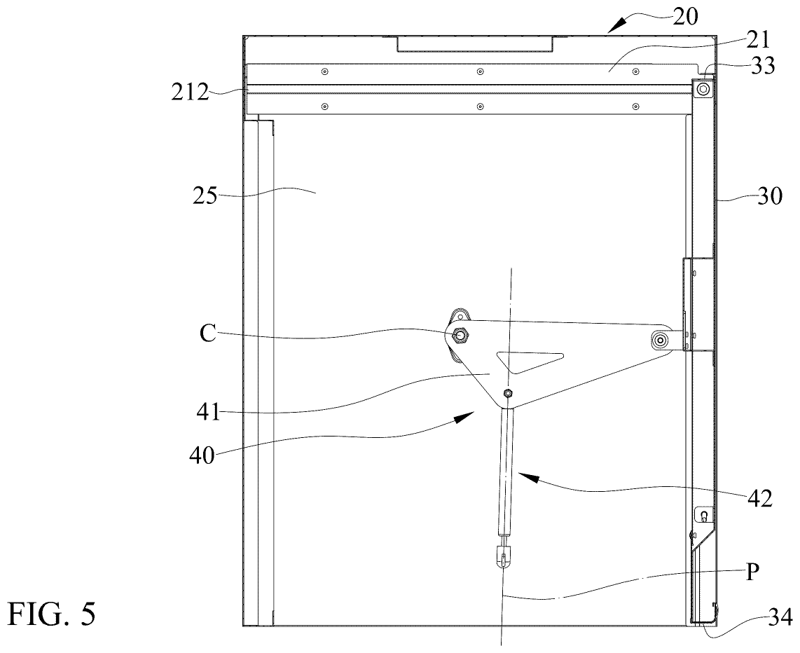

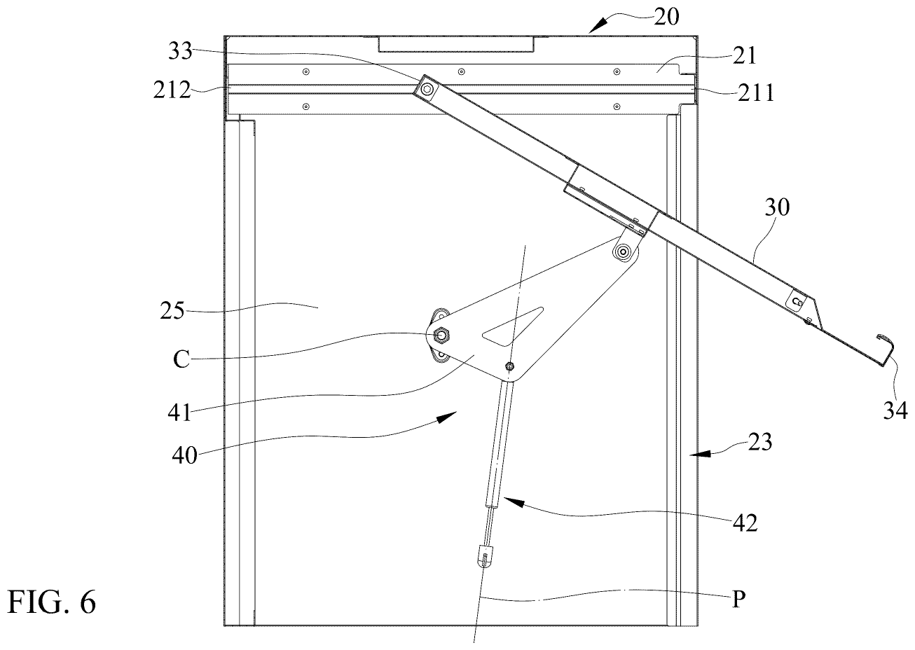

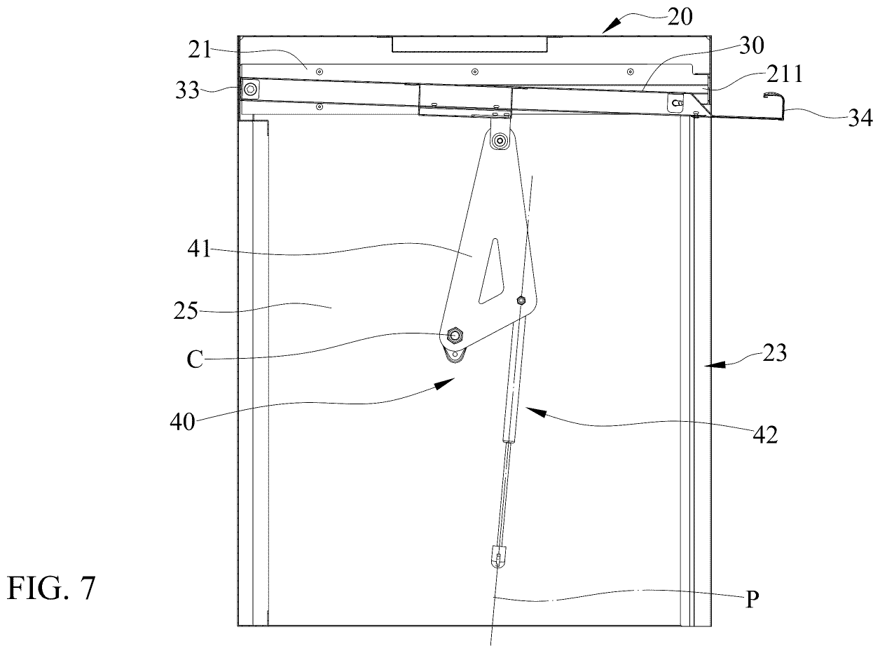

Referring to FIGS. 1 to 7, this embodiment provides a cabinet 10, which includes a cabinet body 20, a door panel 30, and an opening and closing mechanism 40.

A slide rail 21 and a first pivoting portion 22 are disposed within the cabinet body 20.

The door panel 30 has a sliding portion 31 and a second pivoting portion 32, and the sliding portion 31 is rotatably and slidably connected to the slide rail 21.

The opening and closing mechanism 40 includes a linkage member 41, which has a third pivoting portion 411 pivotally connected to the first pivoting portion 22 and a fourth pivoting portion 412 pivotally connected to the second pivoting portion 32.

One side of the cabinet body 20 along a horizontal direction is provided with an opening 23. The slide rail 21 extends linearly along the horizontal direction. The slide rail 21 has a front end 211 adjacent to the opening 23 and a rear end 212 away from the opening 23. The first pivoting portion 22 is disposed below the slide rail 21 along a vertical direction. The cabinet body 20 defines a virtual pivoting axis C passing through the first pivoting portion 22 and extending along the horizontal direction. The linkage member 41 is rotatable relative to the cabinet body 20 about the pivoting axis C. The door panel 30 has a top end 33 and a bottom end 34 opposite the top end 33. The sliding portion 31 is adjacent to the top end 33. The second pivoting portion 32 is disposed between the top end 33 and the bottom end 34. The door panel 30 is movable between a closed position and an open position. When the door panel 30 is in the closed position, the top end 33 is moved near the front end 211, and the bottom end 34 is moved near a lower edge of the opening 23 along the vertical direction, thereby closing the opening 23. When the door panel 30 is in the open position, the sliding portion 31 is moved near the rear end 212, and the bottom end 34 is moved near an upper edge of the opening 23 along the vertical direction, thereby not closing the opening 23.

A fifth pivoting portion 24 is disposed within the cabinet body 20. The linkage member 41 is provided with a sixth pivoting portion 413. The opening and closing mechanism 40 includes a damper 42. The damper 42 is provided with a seventh pivoting portion 421 and an eighth pivoting portion 422. The damper 42 is retractable to change a distance between the seventh pivoting portion 421 and the eighth pivoting portion 422. The seventh pivoting portion 421 is pivotally connected to the fifth pivoting portion 24. The eighth pivoting portion 422 is pivotally connected to the sixth pivoting portion 413.

The fifth pivoting portion 24 is disposed below the first pivoting portion 22 along the vertical direction. The opening and closing mechanism 40 defines a reference surface P parallel to the pivoting axis C and passing through the seventh pivoting portion 421 and the eighth pivoting portion 422. When the door panel 30 is in the closed position, the third pivoting portion 411 is located on a side of the reference surface P opposite to the opening 23, and the fourth pivoting portion 412 is located on the other side of the reference surface P adjacent to the opening 23. When the door panel 30 is in the open position, both the third pivoting portion 411 and the fourth pivoting portion 412 are located on the side of the reference surface P opposite to the opening 23.

The sliding portion 31 is provided with a shaft rod 311 and a circular sliding block 312. The sliding block 312 is sleeved around the shaft rod 311 and disposed within the slide rail 21.

The side of the cabinet body 20 along the horizontal direction is provided with a side plate 25 adjacent to the opening 23. The slide rail 21 is connected to an upper edge of the side plate 25 along the vertical direction. The first pivoting portion 22 is disposed on the side plate 25.

The cabinet 10, through the aforementioned structure, allows the user to easily lift or close the door panel 30. To lift the door panel 30, the user only needs to pull the bottom end 34 outward in an upward-slanting direction. This action not only lifts the door panel 30 but also, through the linkage of the opening and closing mechanism 40, enables the door panel 30 to be horizontally inserted into the cabinet body 20. Conversely, to close the door panel 30, the user simply pulls the bottom end 34 outward in a downward-slanting direction. This action not only draws the door panel 30 out of the cabinet body 20 but also, through the linkage of the opening and closing mechanism 40, allows the door panel 30 to vertically close the opening 23.

Although specific embodiments have been illustrated and described, numerous modifications and variations are still possible without departing from the scope of the invention. The scope of the invention is limited by the accompanying claims.

1. A cabinet, comprising:
a cabinet body, wherein a slide rail and a first pivoting portion are disposed within the cabinet body;
a door panel having a sliding portion and a second pivoting portion, and wherein the sliding portion is rotatably and slidably connected to the slide rail; and
an opening and closing mechanism including a linkage member, and wherein the linkage member has a third pivoting portion pivotally connected to the first pivoting portion and a fourth pivoting portion pivotally connected to the second pivoting portion.

2. The cabinet of claim 1, wherein one side of the cabinet body along a horizontal direction is provided with an opening, wherein the slide rail extends linearly along the horizontal direction, wherein the slide rail has a front end adjacent to the opening and a rear end away from the opening, wherein the first pivoting portion is disposed below the slide rail along a vertical direction, wherein the cabinet body defines a virtual pivoting axis passing through the first pivoting portion and extending along the horizontal direction, wherein the linkage member is rotatable relative to the cabinet body about the pivoting axis, wherein the door panel has a top end and a bottom end opposite the top end, wherein the sliding portion is adjacent to the top end, wherein the second pivoting portion is disposed between the top end and the bottom end, and wherein the door panel is movable between a closed position and an open position;
wherein when the door panel is in the closed position, the top end is moved near the front end, and the bottom end is moved near a lower edge of the opening along the vertical direction, thereby closing the opening;
wherein when the door panel is in the open position, the sliding portion is moved near the rear end, and the bottom end is moved near an upper edge of the opening along the vertical direction, thereby not closing the opening.

3. The cabinet of claim 2, wherein a fifth pivoting portion is disposed within the cabinet body, wherein the linkage member is provided with a sixth pivoting portion, wherein the opening and closing mechanism includes a damper, wherein the damper is provided with a seventh pivoting portion and an eighth pivoting portion, wherein the damper is retractable to change a distance between the seventh pivoting portion and the eighth pivoting portion, wherein the seventh pivoting portion is pivotally connected to the fifth pivoting portion, and wherein the eighth pivoting portion is pivotally connected to the sixth pivoting portion.

4. The cabinet of claim 3, wherein the fifth pivoting portion is disposed below the first pivoting portion along the vertical direction, wherein the opening and closing mechanism defines a reference surface parallel to the pivoting axis and passing through the seventh pivoting portion and the eighth pivoting portion;
wherein when the door panel is in the closed position, the third pivoting portion is located on a side of the reference surface opposite to the opening, and the fourth pivoting portion is located on the other side of the reference surface adjacent to the opening;
wherein when the door panel is in the open position, both the third pivoting portion and the fourth pivoting portion are located on the side of the reference surface opposite to the opening.

5. The cabinet of claim 1, wherein the sliding portion is provided with a shaft rod and a circular sliding block, and wherein the sliding block is sleeved around the shaft rod and disposed within the slide rail.

6. The cabinet of claim 2, wherein the side of the cabinet body along the horizontal direction is provided with a side plate adjacent to the opening, wherein the slide rail is connected to an upper edge of the side plate along the vertical direction, and wherein the first pivoting portion is disposed on the side plate.
